(19) United States
(12) Patent Application Publication
(10) Pub. No.: US 2014/0358638 A1
(43) Pub. Date: Dec. 4, 2014

(54) DYNAMIC INTELLIGENT LEAD IDENTIFIER

(71) Applicant: SUDEEP SUKUMAR, Adoor (IN)

(72) Inventor: SUDEEP SUKUMAR, Adoor (IN)

(73) Assignee: SAP AG, Walldorf (DE)

(21) Appl. No.: 13/909,423

(22) Filed: Jun. 4, 2013

(51) Int. Cl. G06Q 30/02

(52) U.S. Cl. CPC G06Q 30/0204
USPC 705/7.33

(57) ABSTRACT

Data in one or more data repositories managed by a business software framework used by a sales organization can be used in creating a set of profiles corresponding to customers of the sales organization. The profiles can reflect a set of customer characteristic parameters extracted from the data relevant to the customer. The customers can be grouped into families based on common values of the customer characteristic parameters in the customer profiles. Sales interaction data relating to a sales interaction of a customer and the customer profile of the first customer can be applied against the families of profiles to identify one or more commonalities between the sales interaction data, the customer profile, and the customer profiles of one or more other customers. A new lead can be generated for a second customer based on the one or more commonalities.

### TECHNICAL FIELD

The subject matter described herein relates to approaches to identification of leads, for example for sales operations, based on analysis of customer data.

### BACKGROUND

Persons employed in sales positions, such as for example sale representatives, sales agents, and the like (referred to in this disclosure using the generic term “sales staff”) can often fail to take full advantage of available sales opportunities due to a lack of timely data regarding potential leads, target contacts, and the like. Modern enterprise resource planning (ERP) systems customer relationship management (CRM) systems, and other business software frameworks typically include massive amounts of data that should be usable to improve sales tactics and execution of dales activities. However, despite the existence of such data, it is not typically organized or presented in a manner that can support sales activities in a truly beneficial manner.

A typical CRM or other business software system, includes functionality that assists in organizing, automating, and synchronizing, etc. of functionality relating to sales, marketing, customer service, technical support, and the like, and generally includes information regarding items purchased by customers as well as other data relating to the various customers. However, existing CRM systems or other systems that provide at least some of their capabilities generally lack any ability to identify leads for potential sales based on information about two or more otherwise unrelated customers. For example, a sales outcome of, or other data collected and maintained by the CRM system regarding one or more purchases, preferences, or other activities of a first customer (e.g. a specific type of product purchased, a number of products purchased, an industry type of the first company, etc.), generally cannot be used to identify other current and future customers that might have similar purchasing interests, preferences, etc. with sufficient timeliness or predictive value to be of use to sales representatives.

### SUMMARY

Consistent with one or more implementations of the current subject matter, an improved approach to managing of data relevant to improved sales performance can be applied. Among other potential advantages, an approach including one or more of the features described herein or similar or equivalent features can assist sales staff in identifying leads based on generated profiles characterizing one or more parameters representative of two or more customers. The generated profiles can group customers based on commonalities or similarities between customers. Activities of a first customer can be used to predict preferences or other characteristics of another customer, and these predictions can be used to generate leads.

In one aspect, a method includes accessing data in one or more data repositories managed by a business software framework used by a sales organization. The accessed data is used as predictive model input data. The method further includes creating a set of profiles in which each profile corresponds to a customer of a plurality of customers of the sales organization. The profiles reflect a set of customer characteristic parameters extracted from data relevant to the customer in the accessed predictive model data. The plurality of customers are grouped into a plurality of families based on common values of the customer characteristic parameters in the customer profiles, and sales interaction data relating to a sales interaction of a first customer of the plurality of customers and the customer profile of the first customer are applied against the families of profiles to identify one or more commonalities between the sales interaction data and the customer profile of the first customer and customer profiles of one or more other customers in the plurality of customers. A new lead is generated for a second customer of the plurality of customers based on the one or more commonalities.

In some variations one or more of the following features can optionally be included in any feasible combination. The set of customer characteristic parameters can be identified based on a pattern analysis of the data from the one or more data repositories. The pattern analysis can include determining those customer characteristic parameters that are most relevant to identifying commonalities between customer profiles. The sales interaction can include an advancement of a sales process from one phase to a subsequent phase of the sale process. A method can further include at least one of re-evaluating the set of customer characteristic parameters and defining a new set of customer characteristic parameters upon detecting that a change has occurred to metadata used in a sales process of the sales organization. The re-evaluating can include changing the set of customer characteristic parameters, and the changing can include at least one of adding one or more new characteristic parameters from the set of characteristic parameters, deleting one or more existing characteristic parameters from the set of characteristic parameters, modifying the one or more existing characteristic parameters in the set of characteristic parameters, and altering a prioritization of the characteristic parameters in the set of characteristic parameters.

Implementations of the current subject matter can include, but are not limited to, systems and methods including one or more features described herein as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to customer relationship management, sales force automation, enterprise resource planning systems, customer relationship management systems, or other business software solutions or frameworks, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a lead identification framework consistent with implementations of the current subject matter;

FIG. 2 shows a process flow diagram illustrating aspects of a method having one or more features consistent with implementations of the current subject matter;

FIG. 3 shows a diagram illustrating aspects of a system having features consistent with implementations of the current subject matter; and

FIG. 4 shows a diagram illustrating aspects of another system having features consistent with implementations of the current subject matter.

When practical, similar reference numbers denote similar structures, features, or elements.

### DETAILED DESCRIPTION

Consistent with implementations of the current subject matter, predictive models are employed in providing improved sales leads for use by sales staff of an organization. Use of the predictive models can include generation of a profile for each of multiple customers of the organization, grouping of the profiles into families or other related groups of profiles that share at least some parameters in common, and making of predictions about purchasing behavior, preferences, etc. of a first customer based similarities of the first customer to other customers.

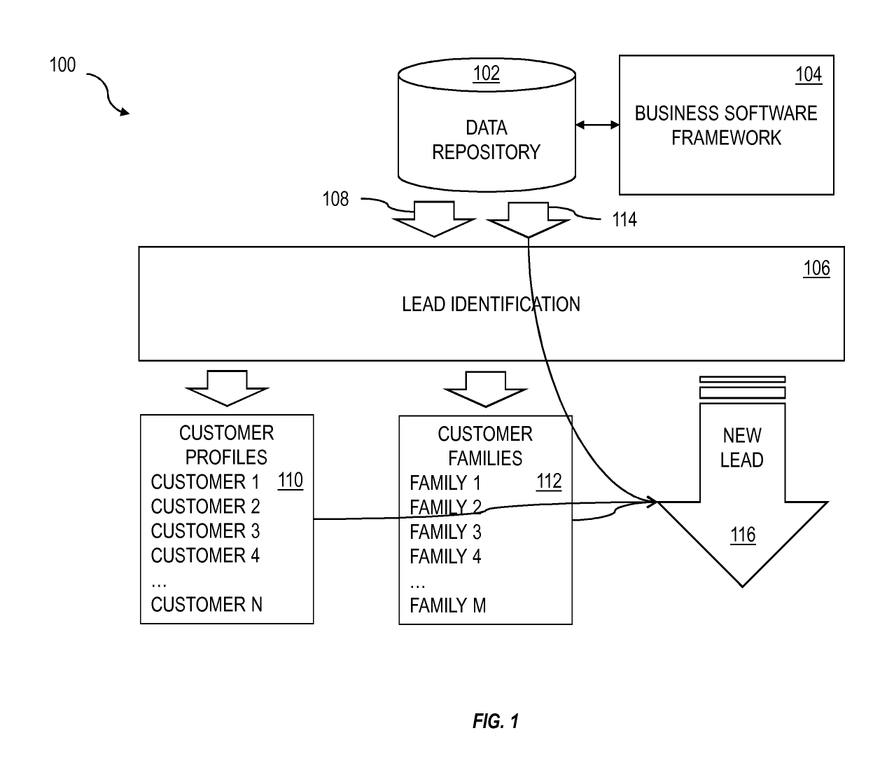

FIG. 1 shows a diagram 100 illustrating features that can be present in a computing framework consistent with implementations of the current subject matter. One or more data repositories 102 can include data managed by a business software framework 104, such as for example a CRM system, an ERP system, or the like. The managed data can include both master data and transactional data relating to a plurality of customers of an organization that uses some group of features of the business software framework 104. As used herein, master data generally refers to basic business data that are used across multiple systems, applications, and/or processes, and that generally do not change frequently. Transactional data generally refers to data describing an event (e.g. a change to data occurring as a result of a transaction) and typically includes temporal data as well as one or more changes to existing records in a database (the change as a result of a transaction). In further variations, the one or more repositories 102 can include data managed by a first business software framework that works in cooperation with one or more business software systems that are provided by other service providers than the service provider providing the first business software framework.

The data in the one or more repositories 102 can be accessed by lead identification functionality 106 as predictive model input data 108, which can be implemented as one or more software modules, agents, etc., which can be executed on a same computing system or computing systems that provide one or more other features of the business software framework 102. Alternatively, the lead identification functionality 106 can be provided via one or more computing systems that are external to the computing system or computing systems that provide one or more other features of the business software framework 102.

The lead identification functionality 106 can create a set of profiles 110, each of which corresponds to a customer of a plurality of customers with whom the organization has done business or wishes to do business. The profile 110 for each customer can reflect a set of customer characteristic parameters extracted from data relevant to the customer from the one or more repositories. The set of customer characteristic parameters can include, for example, a size of the customer company (e.g. number of employees, total annual revenues, etc.), an age of the customer company (e.g. how long since the company was founded), a type of company (e.g. start-up, early stage, venture-funded, private, public, etc.), a primary industry of the company, a location of the company, demographic data about one or more purchasing decision makers at the customer, characteristics of previous purchasing transactions of the customer (e.g. deal size, types of product purchased, and the like. In some implementations of the current subject matter, the set of customer characteristic parameters are identified based on a pattern analysis of the data from the one or more data repositories 102.

The pattern analysis can include data mining features or the like for determining those customer characteristic parameters that are most relevant to identifying commonalities between customer profiles. In this manner, the lead identification functionality 106 can include self-learning aspects that can be used to generate metadata that define the customer characteristic parameters to be used in creating the profiles based on the input data.

In some further implementations of the current subject matter, the self-learning features can include an ability to adapt to changes in a business model underlying sales processes. For example, changes in a business model can occur based on changes to metadata defining underlying business objects used in the sales process. The business objects and their metadata can be stored in the one or more data repositories 102. Upon detection of a change in metadata values defining a sales process, the lead identification functionality 106 can optionally induce a re-evaluation of the set of customer characteristic parameters defining existing profiles 110. The lead identification functionality 106 can also optionally create new sets of customer characteristic parameters for one or more new profiles 110 based on the detection of a change in the business model. In this manner, the lead identification functionality 106 can adapt over time to changes in sales processes, business models, customer characteristics, and other factors that can affect the accuracy of predictive models used by the lead identification functionality 106. In some examples, the changes to one or more sets of customer characteristic parameters can include addition or subtraction of characteristic parameters from a set, modification of one or more characteristic parameters in a set, altering a prioritization of the characteristic parameters in a set, or the like. The prioritization of characteristic parameters can in some implementations of the current subject matter include weighting factors for the various characteristic parameters, an order of analysis, or the like.

The data mining operation or operations used in identifying the set of customer characteristic parameters can include analyses of historical purchasing data for customers of the organization, master data for the customers, other characteristics of the customers, etc. Optionally, the data mining can be performed only on data pertaining to the customers of the organization. In other variations, the data mining can be applied to anonymized data of other organizations, for example if the business software framework 102 is offered as part of a software as a service (SaaS) configuration or other multi-tenant offering in which multiple organizations are supported on a single system or set of systems in a manner that segregates the data of the multiple organizations. In this and potentially other configurations, it can be possible to include anonymized, aggregated, etc. data of multiple organizations outside of the organization to improve the identifying of the set of customer characteristic parameters for use in generating customer profiles.

Based on the values of the customer characteristic parameters in the profile for each of the customers of the organization, the customers can be grouped into “families” 112 (e.g. clusters or the like) or other groups based on common values of the customer characteristic parameters in the customer profiles 110. A customer can belong to multiple families 112 based on different customer characteristic parameters. For example, a first family might be defined by specific values or ranges of values of customer characteristic parameters including a number of employees, location, and technology area, while a second family might be defined by specific values or ranges of values of customer characteristic parameters including annual revenues, age of company, and average size of purchasing transactions over a defined period of time. Depending on the specific values or values ranges defined for each family 112, the profile 110 of given company might place that company into both of these families 112.

When a sales interaction with a first customer progresses to a new phase as tracked by one or more functions or features of the business software framework, sales interaction data 114 relating to the sales interaction and the customer profile of the first customer are dynamically applied against the families of profiles of other customers to identify one or more commonalities between the sales interaction data and the customer profile of the first customer and customer profiles of one or more other customers. Using the identified commonalities, the lead identification functionality generates a new lead 116 for a different customer.

A relationship-based customer pricing engine can in some implementations be configured to further enhance the generated leads by generating one or more sales incentives to be offered to the second customer. Optionally, the sales incentives can be based on a customer rating or other data that can be included in the customer profiles.

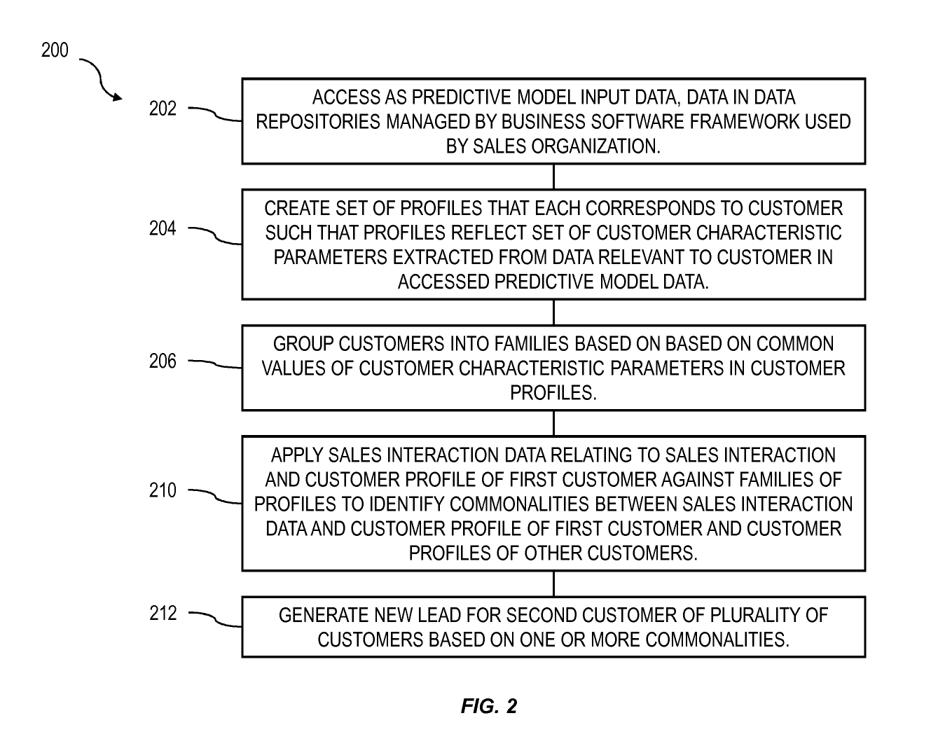

FIG. 2 shows a process flow chart 1000 illustrating features of a method consistent with an implementation of the current subject matter. One or more of these features can be included in other implementations. Data in one or more data repositories managed by a business software framework used by a sales organization are accessed at 202 for use as predictive model data. At 204, a profile is created for each customer of a plurality of customers of the sales organization. A profile can be created for all customers of the organization, or alternatively, the plurality of customers can be a subset of the group of all customers of the sales organization. The profile created for each customer can be based on a profile definition, which can reflect a set of customer characteristic parameters extracted from data relevant to the customer in the accessed predictive model data. Profiles can be dynamically generated based on a pattern recognition analysis using the predictive model input data.

At 206, the plurality of customers can be grouped into a plurality of families based on based on common values of the customer characteristic parameters in the customer profiles. Sales interaction data relating to a sales interaction of a first customer of the plurality of customers and the customer profile of the first customer can be applied at 210 against the families of profiles to identify one or more commonalities between the sales interaction data and the customer profile of the first customer and customer profiles of one or more other customers, and at 212 a new lead for a second customer of the plurality of customers can be generated based on the one or more commonalities. The sales interaction can include an advancement of a sales process from one phase to a subsequent phase of the sale process (e.g. going from a lead to an opportunity, going from an opportunity to an offer, going from an offer to a completed purchase, etc.).

Optionally, the new lead can be promoted, for example by display to a user via a user interface screen, by an electronic message (a voice or text-based message sent to a computing device a mobile device, etc.), by generation of a printed media, etc.

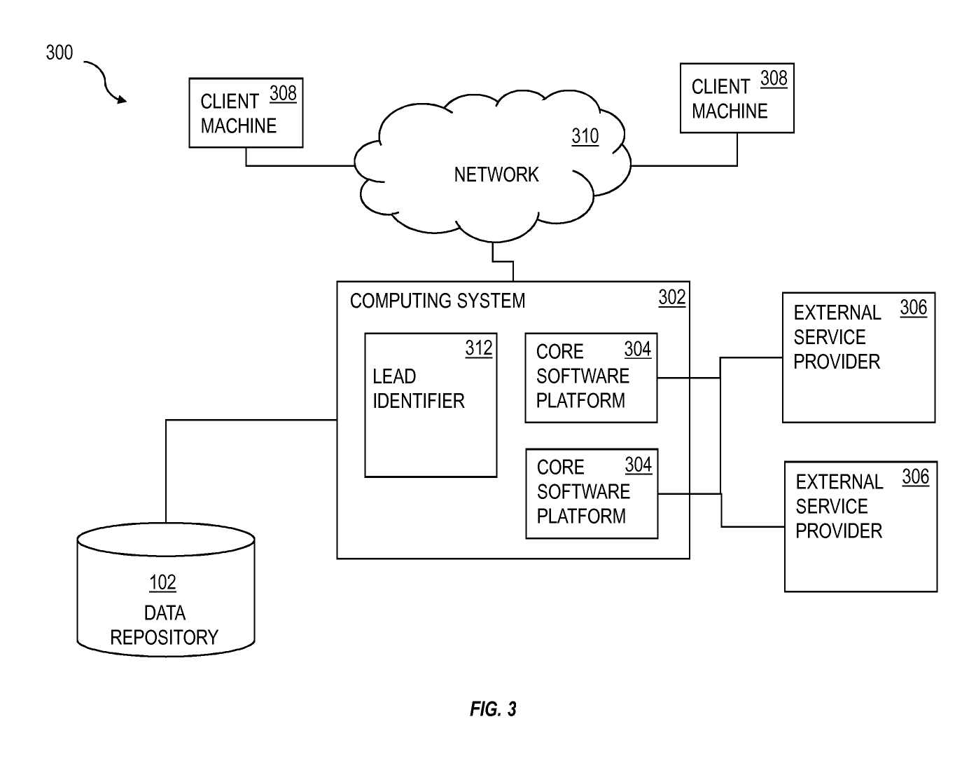

The core software platform of a business software framework 102 as described herein can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 3 shows a diagram of a system consistent with such an implementation. A computing system 302 can include one or more core software platform modules 304 providing one or more features of the business software system. The computing system can also aggregate or otherwise provide a gateway via which users can access functionality provided by one or more external service providers 306. Client machines 308 can access the computing system, either via a direct connection, a local terminal, or over a network 310 (e.g. a local area network, a wide area network, a wireless network, the Internet, or the like). A lead identification agent 106 can be hosted on the computing system 302 or alternatively, on an external system accessible over a network connection. The lead identification agent 106 can optionally include one or more discrete software and/or hardware modules that perform operations such as those described herein.

The lead identification agent 106 can access one or more data repositories 102 (e.g. process repositories, scenarios repositories, transactional data repositories, etc.) that can store definitions of business scenarios, business processes, and one or more business configurations as well as data, metadata, master data, etc. relating to definitions of the business scenarios, business processes, and one or more business configurations, and/or concrete instances of the data objects (e.g. business objects) that are relevant to a specific instance of the business scenario or a business process. In some examples, the definition can optionally be stored as a business object. In some implementations, the business object can include a template definition of a standard business process. The template definition that can optionally be modified via one or more extensions that are stored in the one or more data repositories 102, which can include a metadata repository.

Smaller organizations can also benefit from use of business software functionality. However, such an organization may lack the necessary hardware resources, IT support, and/or consulting budget necessary to make use of a standalone business software software architecture product and can in some cases be more effectively served by a software as a service (SaaS) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of an business software system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

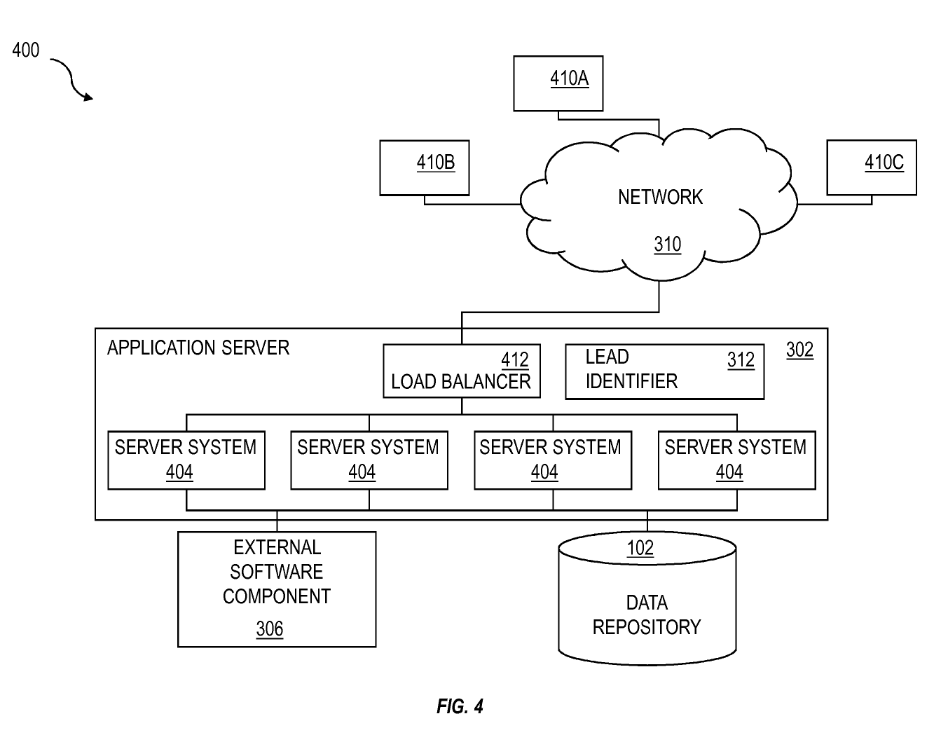

FIG. 4 shows a block diagram of a multi-tenant implementation of a software delivery architecture 400 that includes an application server 302, which can in some implementations include multiple server systems 404 that are accessible over a network 310 from client machines operated by users at each of multiple organizations 410A-410C (referred to herein as “tenants” of a multi-tenant system) supported by a single software delivery architecture. For a system in which the application server 302 includes multiple server systems 404, the application server 302 can include a load balancer 412 to distribute requests and actions from users at the one or more organizations 410A-410C to the one or more server systems 404. Instances of the core software platform 304 (not shown in FIG. 4) can be executed in a distributed manner across the server systems 404. A user can access the software delivery architecture across the network using a thin client, such as for example a web browser or the like, or other portal software running on a client machine. The application server 302 can access data and data objects stored in one or more data repositories 102. The application server 302 can also serve as a middleware component via which access is provided to one or more external software components 306 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 302 that includes multiple server systems 404 that handle processing loads distributed by a load balancer 412. Potential benefits from such an arrangement can include, but are not limited to, high and reliably continuous application server availability and minimization of unplanned downtime, phased updating of the multiple server systems 404 to permit continuous availability (one server system 404 can be taken offline while the other systems continue to provide services via the load balancer 412), scalability via addition or removal of a server system 404 that is accessed via the load balancer YY12, and de-coupled lifecycle processes (such as for example system maintenance, software upgrades, etc.) that enable updating of the core software independently of tenant-specific customizations implemented by individual tenants.

As in the example illustrated in FIG. 3, the one or more data repositories 102 can store a business object that represents a template definition of a standard business process. Each individual tenant 410A-410C can customize that standard template according to the individual business process features specific to business of the organization to which that tenant is assigned. Customizations can be stored as extensions in the one or more data repositories 102, which can include a metadata repository.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
accessing, as predictive model input data, data in one or more data repositories managed by a business software framework used by a sales organization;
creating a set of profiles, each profile corresponding to a customer of a plurality of customers of the sales organization; the profiles reflecting a set of customer characteristic parameters extracted from data relevant to the customer in the accessed predictive model data;
grouping the plurality of customers into a plurality of families based on common values of the customer characteristic parameters in the customer profiles;
applying sales interaction data relating to a sales interaction of a first customer of the plurality of customers and the customer profile of the first customer against the families of profiles to identify one or more commonalities between the sales interaction data and the customer profile of the first customer and customer profiles of one or more other customers in the plurality of customers; and
generating a new lead for a second customer of the plurality of customers based on the one or more commonalities.

2. A computer program product as in claim 1, wherein the operations further comprise identifying the set of customer characteristic parameters based on a pattern analysis of the data from the one or more data repositories.

3. A computer program product as in claim 2, wherein the pattern analysis comprises determining those customer characteristic parameters that are most relevant to identifying commonalities between customer profiles.

4. A computer program product as in claim 1, wherein the sales interaction comprises an advancement of a sales process from one phase to a subsequent phase of the sale process.

5. A computer program product as in claim 1, wherein the operations further comprise at least one of re-evaluating the set of customer characteristic parameters and defining a new set of customer characteristic parameters upon detecting that a change has occurred to metadata used in a sales process of the sales organization.

6. A computer program product as in claim 5, wherein the re-evaluating comprises changing the set of customer characteristic parameters, the changing comprising at least one of adding one or more new characteristic parameters from the set of characteristic parameters, deleting one or more existing characteristic parameters from the set of characteristic parameters, modifying the one or more existing characteristic parameters in the set of characteristic parameters, and altering a prioritization of the characteristic parameters in the set of characteristic parameters.

7. A system comprising:
at least one programmable processor; and
a machine-readable medium storing instructions that, when executed by the at least one programmable processor, cause the at least one programmable processor to perform operations comprising:
accessing, as predictive model input data, data in one or more data repositories managed by a business software framework used by a sales organization;
creating a set of profiles, each profile corresponding to a customer of a plurality of customers of the sales organization; the profiles reflecting a set of customer characteristic parameters extracted from data relevant to the customer in the accessed predictive model data;
grouping the plurality of customers into a plurality of families based on common values of the customer characteristic parameters in the customer profiles;
applying sales interaction data relating to a sales interaction of a first customer of the plurality of customers and the customer profile of the first customer against the families of profiles to identify one or more commonalities between the sales interaction data and the customer profile of the first customer and customer profiles of one or more other customers in the plurality of customers; and
generating a new lead for a second customer of the plurality of customers based on the one or more commonalities.

8. A system as in claim 7, wherein the operations further comprise identifying the set of customer characteristic parameters based on a pattern analysis of the data from the one or more data repositories.

9. A system as in claim 8, wherein the pattern analysis comprises determining those customer characteristic parameters that are most relevant to identifying commonalities between customer profiles.

10. A system as in claim 7, wherein the sales interaction comprises an advancement of a sales process from one phase to a subsequent phase of the sale process.

11. A system as in claim 7, wherein the operations further comprise at least one of re-evaluating the set of customer characteristic parameters and defining a new set of customer characteristic parameters upon detecting that a change has occurred to metadata used in a sales process of the sales organization.

12. A system as in claim 11, wherein the re-evaluating comprises changing the set of customer characteristic parameters, the changing comprising at least one of adding one or more new characteristic parameters from the set of characteristic parameters, deleting one or more existing characteristic parameters from the set of characteristic parameters, modifying the one or more existing characteristic parameters in the set of characteristic parameters, and altering a prioritization of the characteristic parameters in the set of characteristic parameters.

13. A computer-implemented method comprising:
accessing, as predictive model input data, data in one or more data repositories managed by a business software framework used by a sales organization;
creating a set of profiles, each profile corresponding to a customer of a plurality of customers of the sales organization; the profiles reflecting a set of customer characteristic parameters extracted from data relevant to the customer in the accessed predictive model data;
grouping the plurality of customers into a plurality of families based on common values of the customer characteristic parameters in the customer profiles;
applying sales interaction data relating to a sales interaction of a first customer of the plurality of customers and the customer profile of the first customer against the families of profiles to identify one or more commonalities between the sales interaction data and the customer profile of the first customer and customer profiles of one or more other customers in the plurality of customers; and
generating a new lead for a second customer of the plurality of customers based on the one or more commonalities.

14. A computer-implemented method as in claim 13, further comprising identifying the set of customer characteristic parameters based on a pattern analysis of the data from the one or more data repositories.

15. A computer-implemented method 14, wherein the pattern analysis comprises determining those customer characteristic parameters that are most relevant to identifying commonalities between customer profiles.

16. A computer-implemented method as in claim 13, wherein the sales interaction comprises an advancement of a sales process from one phase to a subsequent phase of the sale process.

17. A computer-implemented method as in claim 13, further comprising at least one of re-evaluating the set of customer characteristic parameters and defining a new set of customer characteristic parameters upon detecting that a change has occurred to metadata used in a sales process of the sales organization.

18. A computer-implemented method as in claim 17, wherein the re-evaluating comprises changing the set of customer characteristic parameters, the changing comprising at least one of adding one or more new characteristic parameters from the set of characteristic parameters, deleting one or more existing characteristic parameters from the set of characteristic parameters, modifying the one or more existing characteristic parameters in the set of characteristic parameters, and altering a prioritization of the characteristic parameters in the set of characteristic parameters.

19. A computer-implemented method as in claim 13, wherein at least one of the accessing, the creating, the grouping, the applying, and the generating is performed by a system comprising at least one programmable processor.
